(19) United States
(12) Patent Application Publication
(10) Pub. No.: US 2011/0181712 A1
(43) Pub. Date: Jul. 28, 2011

(54) METHOD AND APPARATUS FOR TRACKING OBJECTS

(75) Inventors: Shang Sian YOU, Taichung City (TW); Jium Ming LIN, Hsinchu City (TW); Po Kuang CHANG, Jhongli City (TW); Jen Chao LU, Taichung City (TW); Lih Guong JANG, Hsinchu City (TW)

(73) Assignee: INDUSTRIAL TECHNOLOGY RESEARCH Institute, Chutung (TW)

(21) Appl. No.: 12/469,607

(22) Filed: May 20, 2009

(30) Foreign Application Priority Data
Dec. 19, 2008 (TW) 097149605

(51) Int. Cl. H04N 7/18; G01S 15/66; G01C 3/08; G06K 9/00

(52) U.S. Cl. 348/135; 367/104; 356/4.01; 382/103; 348/E07.085

(57) ABSTRACT

A method utilizing an ultrasonic distance sensor to measure distances between the sensor and an object includes the steps of: identifying an object using a first object tracking apparatus; adjusting a first rotation direction of the first object tracking apparatus to pinpoint the object; measuring a distance between the object and the first object tracking apparatus; and obtaining a location of the object in accordance with the distance and the first rotation direction.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The disclosure relates to a method and apparatus for tracking objects.

2. Description of Related Art Including Information Disclosed Under 37 CFR 1.97 and 37 CFR 1.98.

In the applications of various public surveillance systems, the limitation of the field of view of a camera results in some areas being “blind” or unmonitored by the surveillance system. However, utilizing additional cameras increases the costs of the surveillance systems. Thus, U.S. Pat. No. 6,359,647 disclosing a predictive location determination algorithm and U.S. Pat. No. 7,242,423 disclosing the concept of linked zones utilize multiple tracking cameras in indoor or outdoor settings to efficiently monitor objects and reduce the blind areas.

The calculation load of the mentioned system with multiple tracking cameras is generally divided into three parts. First, a moving object is tracked in accordance with coordinates of the object, which is analyzed by a back-end control station with an image processing algorithm. Second, the coordinates of the object are forwarded to the processor of a front-end camera to control the camera's carrier to face the object. Third, when the object exits the field of view of the camera, the back-end control station forwards the coordinates of the object to another camera in order to continuously track the object.

However, the modes of analyzing the coordinates of an object by the image processing algorithm performed by a back-end control station need to utilize more complex calculations and require more time to obtain the position of the object. Moreover, there is no standard communication protocol among cameras. The weighting information has to be forwarded to the back-end main station (PC or server) for recalculating to complete the handoff procedures between cameras. Therefore, these types of systems with multiple tracking cameras require a station with high processing performance to continuously track a moving object and to complete the handoff procedure in real time.

Accordingly, there is a need to reduce the calculation load, to establish a forwarding protocol among cameras and to implement a front-end embedded system, so as to meet industrial requirements.

### BRIEF SUMMARY OF THE INVENTION

A method and apparatus for tracking objects are disclosed. This method utilizes an ultrasonic distance sensor to measure the distance between the sensor and an object. By using the trigonometric function with the distances and the parameters of the sensor's location, the location of the object is continuously obtained.

One embodiment discloses an object tracking method, comprising the steps of: identifying an object using a first object tracking apparatus; adjusting a first rotation direction of the first object tracking apparatus to pinpoint the object; measuring a distance between the object and the first object tracking apparatus; and obtaining a location of the object in accordance with the distance and the first rotation direction.

Another embodiment an object tracking apparatus comprises an image, a distance sensor and a rotation mechanism. The image capture element is used for detecting an object. The distance sensor fixed together with the image capture element is used for measuring a distance between the object and the distance sensor. The rotation mechanism is used for adjusting a first rotation angle of the image capture element and the distance sensor.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the invention.

FIG. 1 is a flowchart illustrating an exemplary embodiment of the object tracking method.

FIG. 2 is a schematic view of an illustrated diagram of an object tracking system in accordance with an exemplary embodiment.

FIG. 3 illustrates the block diagram of any of two object tracking apparatuses in accordance with an exemplary embodiment.

### DETAILED DESCRIPTION OF THE INVENTION

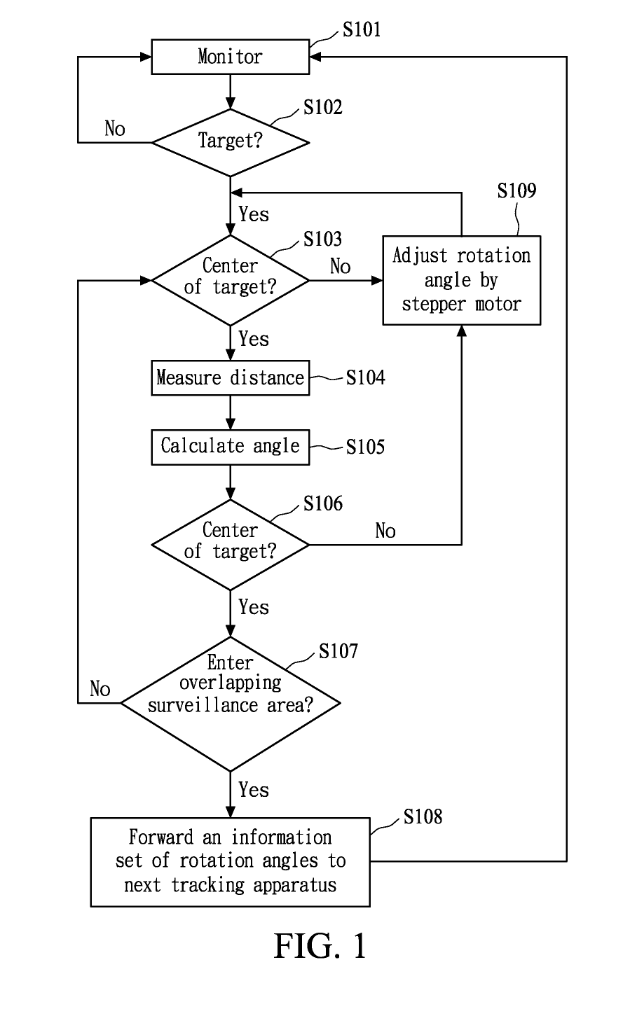

FIG. 1 is a flowchart illustrating an exemplary embodiment of the object tracking method. In step S101, a first object tracking apparatus is monitoring. The first object tracking apparatus comprises a camera, an ultrasonic distance sensor and a rotation mechanism. In step S102, when an unknown object appears, the unknown object is checked according to the data of a database to determine whether the unknown object is a target (known object). If the object is not a target, the operation is returned to step S101 to continue monitoring. If the object is a target, step S103 determines whether the center of the target is pinpointed. In this embodiment, the center of the bottom of the target is defined as the center of the target. If the center of the target is not pinpointed, the step motor of the rotation mechanism is controlled to adjust the monitoring direction of the object tracking apparatus to pinpoint the center of the target. After locating the center of the target, in step S104, the ultrasonic distance sensor is utilized to measure the straight-line distance between the target and the ultrasonic distance sensor. In step S105, the location of the target is obtained by using the trigonometric function with the measured straight-line distance and the known parameters such as the sensor's location and the direction of the rotation mechanism. When the target moves, in step S106, the step motor of the rotation mechanism is controlled again to adjust the monitoring direction of the object tracking apparatus to pinpoint the center of the target.

Steps S103-S106 are repeated to track a target, which moves continuously or a target, which moves intermittently within the surveillance range of the object tracking apparatus. When the target enters the overlapping surveillance area of the first object tracking apparatus and a second object tracking apparatus which is next to the first object tracking apparatus (step S107), the first object tracking apparatus forwards values of rotation angles (a horizontal rotation angle and a vertical rotational angle) to the second object tracking apparatus (step S108). The second object tracking apparatus adjusts its monitoring direction rapidly to track the target in accordance with the set of rotation angles.

In addition to the above-mentioned method, another embodiment is described as follows to enable those skilled in the art to practice the disclosure.

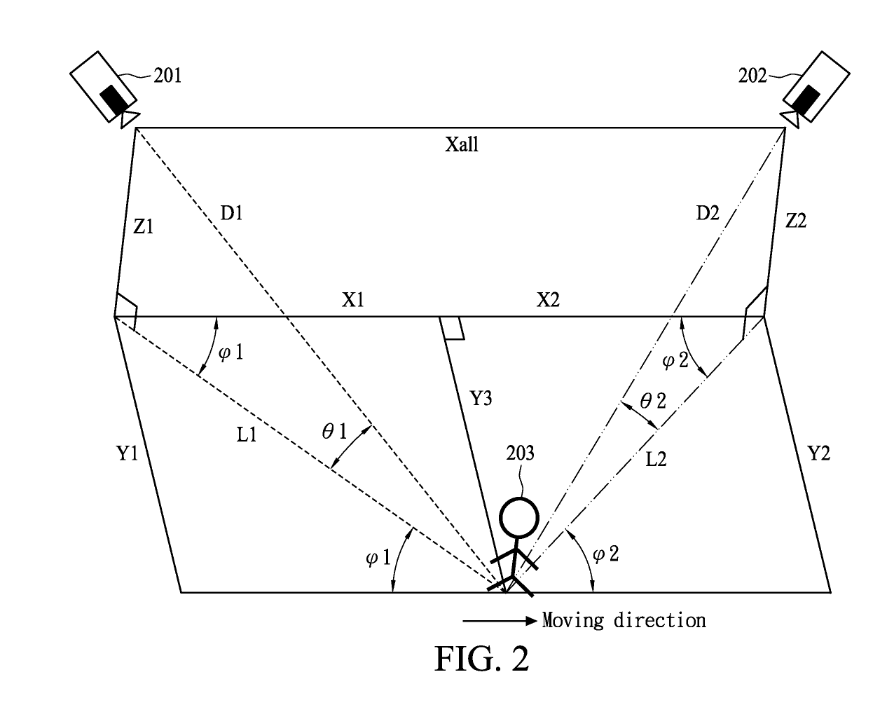

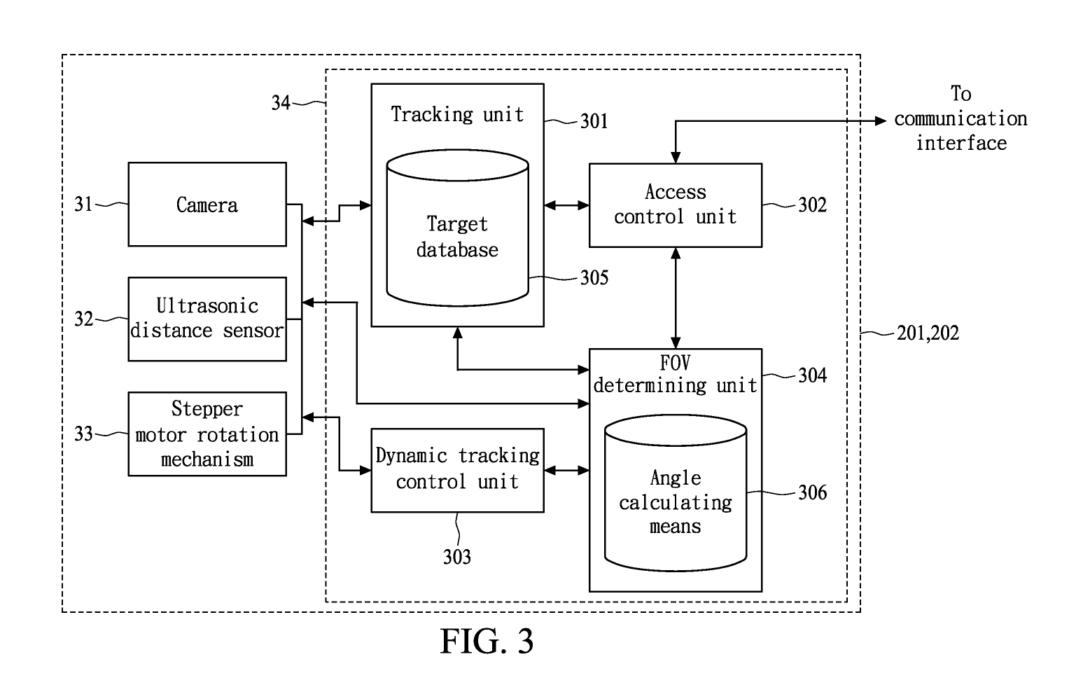

FIG. 2 illustrates the diagram of an object tracking system in accordance with an exemplary embodiment. Two object tracking apparatuses 201 and 202 are mounted at the places with vertical heights of Z1 and Z2 respectively. The distance between two object tracking apparatuses is Xall. FIG. 3 illustrates the block diagram of any of two object tracking apparatuses 201 and 202 in accordance with an exemplary embodiment. Each object tracking apparatus comprises a camera 31, an ultrasonic distance sensor 32, a stepper motor rotation mechanism 33 and an embedded system 34. The camera 31 acts as an image capture element, which can be a visible-light image capture element or an infrared image capture element. The ultrasonic distance sensor 32 acts as a distance sensor. Another choice for the distance sensor is an infrared distance sensor. The rotation mechanism 33 can rotate horizontally and vertically. In the embedded system 34, an unknown object detected by the camera 31 is identified by a tracking unit 301. The identification result is checked with a target database 305, which stores characteristics of targets (known objects). Alternatively, an image frame of the unknown object is forwarded to a back-end computer by an access control unit 302 for performing an identification task. The result of the identification task is then checked with the target database 305 to determine whether the unknown object is a target. If the unknown object is a target 203, a dynamic tracking control unit 303 controls the stepper motor rotation mechanism 33 immediately to adjust the monitoring direction of an object tracking apparatus to pinpoint the center of the target 203.

In this embodiment, the center of the bottom of the target 203 is defined as the center of the target 203. However, the definition of the center of a target is modifiable under different circumstances. After locating the center of the target 203, the ultrasonic distance sensor 32 measures the straight-line distance between the target 203 and the ultrasonic distance sensor 32. In a field of view (FOV) determining unit 304, an angle calculating device or an angle calculating means 306 obtains the location of the target 203 in accordance with the measured straight-line distance and known parameters (the locations of object tracking apparatuses 201 and 202 and the horizontal rotational direction of the stepper motor rotation mechanism 33). When the target 203 enters the overlapped surveillance area of the object tracking apparatuses 201, 202, the object tracking apparatus 201 immediately forwards values of rotation angles to the object tracking apparatus 202.

According to the set of rotation angles, the object tracking apparatus 202 adjusts its monitoring direction rapidly to pinpoint the center of the target 203 for continuous tracking of the target 203. As shown in FIG. 2, the movement direction of the target 203 is same as the indication direction of the arrow. When the target 203 enters the overlapping surveillance area of the object tracking apparatuses 201, 202, in accordance with the distance D1 measured by the ultrasonic distance sensor 32, a horizontal rotation angle φ1, the known height Z1, Z2 and the separation distance Xall, the object tracking apparatus 201 obtains the rotation direction values φ2 and θ2 needed for the object tracking apparatus 202 to pinpoint the center of the target, wherein the horizontal rotation angle φ1 of the stepper motor rotation mechanism 33 can be converted to degrees in accordance with the steps of the stepper motor by a look-up table.

According to the known distance D1, the horizontal rotation angle φ1, the known height Z1, Z2 and the separation distance Xall, the method by which the angle calculating means 306 obtains the values φ2 and θ2 is as follows: By using Z1 and D2, L1 can be obtained by the following equations:

$$\begin{matrix}θ 1 = {sin}^{- 1} ( \frac{Z 1}{D 1} ) , & ( 1 ) \\ L 1 = D 1 cos θ 1. & ( 2 )\end{matrix}$$

By using φ1 and L1, Y1 can be obtained by the following equation:

Y1=L1 sin φ1. (3)

Therefore,

Y1=Y2=Y3=L1 sin φ1. (4)

The horizontal rotation angle needed for the object tracking apparatus 202 to pinpoint the center of the target is

$$\begin{matrix}ϕ 2 = {tan}^{- 1} \frac{Y 3}{X 2} , \\ where {X}_{2} = Xall - X 1 , thus & ( 5 ) \\ ϕ 2 = {tan}^{- 1} \frac{L 1 sin ϕ1}{Xall - L 1 cos ϕ 1} . & ( 6 )\end{matrix}$$

The relationships among L2, φ2 and X2 are

$$\begin{matrix}cos ϕ 2 = \frac{X 2}{L 2 } , & ( 7 ) \\ L 2 = \frac{X 2}{cos ϕ 2} . & ( 8 )\end{matrix}$$

Finally, according to L2 and Z2, θ2 can be obtained by the following equations:

$$\begin{matrix}tan θ 2 = \frac{Z 2}{L 2} , & ( 9 ) \\ θ 2 = {tan}^{- 1} \frac{Z 2}{L 2} , & ( 10 ) \\ θ 2 = {tan}^{- 1} \frac{Z 2 cos ϕ 2}{Xall - L 1 cos ϕ 1} . & ( 11 )\end{matrix}$$

The values of the abovementioned trigonometric calculations can be obtained with a look-up table.

Accordingly, when the target 203 enters the overlapping surveillance area of the object tracking apparatuses 201, 202, the φ2 and θ2 derived by the object tracking apparatus 201 are forwarded to the object tracking apparatus 202. Whenever the target 203 moves back to the surveillance area of the object tracking apparatus 201 or forward to the surveillance area of the object tracking apparatus 202, the object tracking system can seize the location and the movement trajectory of the target 203 and thereby track the target 203 continuously.

Object tracking systems of prior arts rely on back-end computers to perform large calculations for obtaining the location of the target 203. If fluorescent lamps are used in the surveillance areas, the flicker frequencies of fluorescent lamps causes background noises in video images. When the target 203 moves, the calculation load and task difficulty are increased because of the background noises. In contrast to prior art, a tracking/positioning method is proposed in accordance with the embodiment, which utilizes an ultrasonic distance sensor to measure the distance between the sensor and a target. By using the trigonometric function with the distances and the parameters of the sensor's location, the location of the target is continuously obtained. Further, the embodiment of the disclosure reduces the calculation loads of the tracking algorithms. The embodiment of the disclosure also reduces the quantity of forwarding data needed for object tracking apparatuses to track an object and can be more easily implemented in a front-end embedded system.

The above-described exemplary embodiments are intended to be illustrative only. Those skilled in the art may devise numerous alternative embodiments without departing from the scope of the following claims.

1. A method for tracking objects, the method comprising the steps of:
identifying an object using a first object tracking apparatus;
adjusting a first rotation direction of the first object tracking apparatus to pinpoint the object;
measuring a distance between the object and the first object tracking apparatus; and
obtaining a location of the object in accordance with the distance and the first rotation direction.

2. The method of claim 1, further comprising a step of:
obtaining the location of the object with a look-up table.

3. The method of claim 1, further comprising a step of:
obtaining the location of the object and a second rotation direction of a second object tracking apparatus by using a trigonometric function with the distance, the first rotation direction, and known parameters.

4. The method of claim 3, wherein the known parameters comprises at least one value describing a location of an object tracking apparatus.

5. The method of claim 3, further comprising a step of:
forwarding values of the second rotation direction to the second object tracking apparatus.

6. The method of claim 3, wherein a value of the first or second rotation direction comprises a horizontal rotation angle and a vertical rotation angle.

7. The method of claim 1, wherein the first or the second object tracking apparatus comprises an image capture element, a distance sensor and a rotation mechanism.

8. The method of claim 7, wherein the image capture element is a visible-light image capture element or an infrared image capture element.

9. The method of claim 8, wherein the distance sensor is an ultrasonic distance sensor or an infrared distance sensor.

10. The method of claim 7, wherein the rotation mechanism comprises at least one stepper motor.

11. The method of claim 7, wherein the rotation mechanism rotates horizontally or vertically.

12. A apparatus for tracking objects, comprising:
an image capture means for detecting an object;
a distance sensor fixed means together with the image capture element for measuring a distance between the object and the distance sensor; and
a rotation means for adjusting a first rotation angle of the image capture element and the distance sensor.

13. The apparatus of claim 12, further comprising:
an angle calculation component for obtaining a location of the object in accordance with the distance, the first rotation direction, and known parameters.

14. The apparatus of claim 13, wherein the known parameters comprises at least one value describing the location of an object tracking apparatus.

15. The apparatus of claim 13, wherein the angle calculation component is implemented with software, hardware, or a platform with a single processor or with multiple processors.

16. The apparatus of claim 12, further comprising:
an angle calculation means for obtaining a location of the object.

17. The apparatus of claim 12, further comprising:
a tracking unit for performing an identification task or a comparison task for the object.

18. The apparatus of claim 17, wherein the tracking unit comprises a target database storing at least one characteristic of a known object.

19. The apparatus of claim 12, further comprising:
an access control unit for forwarding an image frame of the object to a back-end computer.

20. The apparatus of claim 12, further comprising:
a dynamic tracking control unit for controlling a monitoring direction of the rotation mechanism.

21. The apparatus of claim 12, wherein the image capture element is a visible-light image capture element or an infrared image capture element.

22. The apparatus of claim 12, wherein the distance sensor is an ultrasonic distance sensor or an infrared distance sensor.

23. The apparatus of claim 12, wherein the rotation mechanism comprises at least one stepper motor.

24. The apparatus of claim 12, wherein the rotation mechanism rotates horizontally or vertically.
